(19) United States
(12) Patent Application Publication
(10) Pub. No.: US 2024/0213784 A1
(43) Pub. Date: Jun. 27, 2024

(54) System for Controlling Rails of Battery Charger to Increase Electromagnetic Compatibility

(71) Applicant: LEAR CORPORATION, Southfield, MI (US)

(72) Inventors: Pablo GONZALEZ VIZUETE, Valls (ES); Josep RUIZ RODON, Valls (ES); Edgar ZAHINO ANDRES, Valls (ES); Jordi TOST BARTOLOME, Valls (ES); Carlos BARCELO VERNET, Valls (ES); Adria MARCOS PASTOR, Valls (ES)

(73) Assignee: LEAR CORPORATION, Southfield, MI (US)

(21) Appl. No.: 18/526,096

(22) Filed: Dec. 1, 2023

Related U.S. Application Data
(60) Provisional application No. 63/434,535, filed on Dec. 22, 2022.

(51) Int. Cl. H02J 7/00; H02J 7/04

(52) U.S. Cl. CPC H02J 7/0013; H02J 7/04; H02J 2207/20; H02J 2310/48

(57) ABSTRACT

A charger includes first and second rail circuits and a controller. Each of the first and second rail circuits provide power when activated. The controller activates the first rail circuit without activating the second rail circuit in accordance with a determination that a power greater than a first power and less than a second power is to be provided. The controller activates the first and second rail circuits in accordance with a determination that a power greater than the second power is to be provided. A power difference between the second power and the first power is greater than the first power.

### CROSS-REFERENCE TO RELATED APPLICATIONS

This application claims the benefit of U.S. Provisional Application No. 63/434,535, filed Dec. 22, 2022, the disclosure of which is hereby incorporated in its entirety by reference herein.

### TECHNICAL FIELD

The present disclosure relates to controlling a multi-phase (i.e., multi-rail) charger such as an on-board battery charger of an electrified vehicle.

### BRIEF DESCRIPTION OF THE DRAWINGS

FIG. 1 illustrates a block diagram of an electrical system having a multi-phase (i.e., multi-rail) on-board battery charger (OBC);

FIG. 2 illustrates a block diagram of the electrical system with a detailed depiction of the OBC as a three-phase (i.e., multi-rail) OBC having three phases (i.e., rails);

FIG. 3A illustrates a graph having a plot of a number of rails of the OBC that are activated as a function of electrical power provided by the OBC according to an ordinary rail activation strategy;

FIG. 3B illustrates a graph (“the ordinary rail activation strategy graph”) depicting regions of operation of the OBC in which a phase-shift mode (PSM) control is used for controlling the OBC to provide electrical power and regions of operation of the OBC in which a frequency modulation mode (FMM) control is used for controlling the OBC to provide electrical power when the OBC is operated according to the ordinary rail activation strategy;

FIG. 4 illustrates a top-and-bottom view of the ordinary rail activation strategy graph of FIG. 3B (top graph of FIG. 4) and a graph (“novel rail activation strategy graph”) (bottom graph of FIG. 4), the novel rail activation strategy graph depicting regions of operation of the OBC in which the PSM control is used for controlling the OBC to provide electrical power and regions of operation of the OBC in which the FMM control is used for controlling the OBC to provide electrical power when the OBC is operated according to a novel rail activation strategy;

FIG. 5A illustrates a qualitative efficiency graph in which it can be observed how efficiency would look like with the ordinary rail activation strategy; and

FIG. 5B illustrates a qualitative efficiency graph in which it can be observed how efficiency would look like with the novel rail activation strategy.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

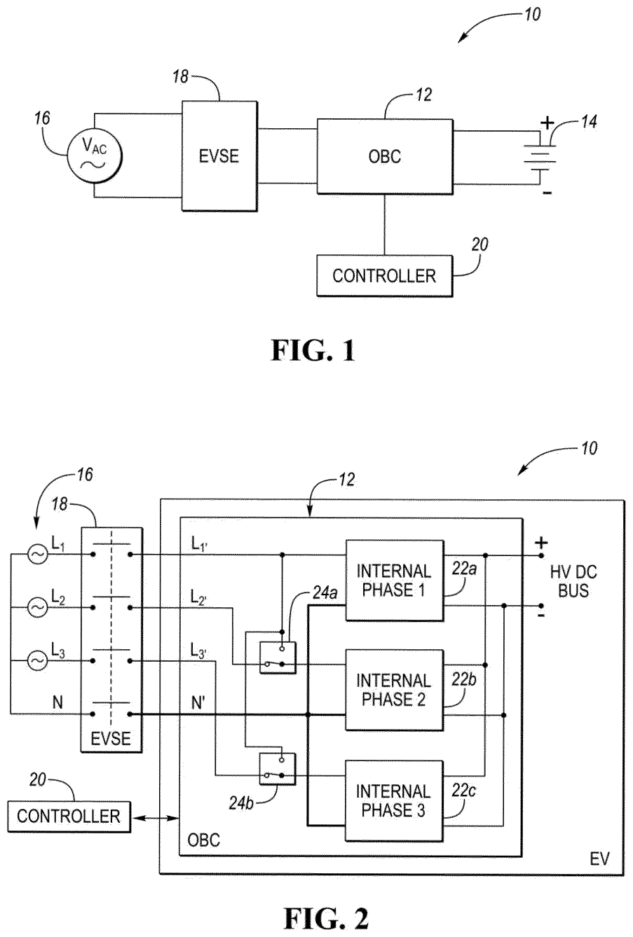

Referring now to FIG. 1, a block diagram of an electrical system 10 having an on-board battery charger (OBC) 12 is shown. OBC 12 is “on-board” an electrified vehicle (EV). OBC 12 is used for charging a traction battery 14 of the EV. OBC 12 converts electrical power absorbed from an AC (alternating current) power source 16 into DC (direct current) electrical power and charges traction battery 14 with the DC electrical power.

Traction battery 14 is a high-voltage (HV) DC traction battery per electrical energy requirements for vehicle propulsion. The terms “electrified vehicle” and “EV” herein encompass any type of vehicle which uses electrical power for vehicle propulsion including battery-only electric vehicles (BEV), hybrid electric vehicles (HEV), plug-in hybrid electric vehicles (PHEV), and the like.

AC power source 16 is typically a mains supply of the electrical grid. OBC 12 charges traction battery 14 using electrical power from mains supply 16. OBC 12 connects to mains supply 16 via an external Electric Vehicle Supply Equipment (EVSE) 18 to absorb electrical power from the mains supply. OBC 12 converts electrical power absorbed from mains supply 16 into DC electrical power. OBC 12 outputs the DC electrical power via a HV DC bus of the vehicle to traction battery 14 for charging the traction battery.

A controller 20 is associated with OBC 12. Controller 20 is an electronic device such as a processor, micro-controller, or the like (e.g., a computer) on-board the EV (e.g., a vehicle controller). Controller 20 is in communication with OBC 12 to control operations of the OBC. Controller 20 controls OBC 12 in converting electrical power from mains supply 16 into DC electrical power and in charging traction battery 14 with the DC electrical power. Controller 20 may be integrated inside the OBC unit. Controller 20 may provide general commands and communication with other vehicle units and phase (rail) dedicated controllers in charge of phase (rail) operation, control, and diagnostics in real time. Controller 20 is also operable to communicate and control other nodes of electrical system 10 and the EV including nodes involved in the charging applications.

Referring now to FIG. 2, with continual reference to FIG. 1, a block diagram of electrical system 10 with a detailed depiction of OBC 12 is shown. OBC 12 is a N-phase (i.e., N-rail) OBC, where N is an integer greater than one. As such, OBC 12 is a multi-phase (i.e., multi-rail) OBC having at least two parallel phases (i.e., rails (or branches)). For example, as shown in FIG. 2, OBC 12 is a three-phase (i.e., three-rail) OBC having first, second, and third rails 22a, 22b, and 22c (collectively, “rails 22”) (each labeled “Internal Phase” in FIG. 2).

To optimize components size and cost, OBC 12 has parallel rails 22 that are activated depending on system (charging) demands. Rails (i.e., rail circuits) 22 have the same electrical circuitry for converting electrical power from mains supply 16 into DC electrical power for charging traction battery 14. For example, each rail 22a, 22b, and 22c has an AC electromagnetic interference (EMI) input filter followed serially by a power factor corrector (PFC), a DC link capacitor, a DC/DC converter, and an output filter (not shown). Controller 20, alone or in conjunction with individual rail controllers (not shown) of rails 22 if provided, controls the operation of the electrical circuitry of rails 22 in converting electrical power from mains supply 16 into DC electrical power and in providing the DC electrical power to traction battery 14.

Each rail 22 is to be connected to mains supply 16 via EVSE 18 for that rail to absorb electrical power from the mains supply and to convert the absorbed electrical power into DC electrical power for charging traction battery 14. Rails 22 are between the input of the OBC, which connects to mains supply 16 via EVSE 18, and the output of the OBC, which connects to traction battery 14 via an HV DC bus of the EV.

OBC 12 further includes input relays (or switches) 24a and 24b (collectively, “input relays 24”). Input relays 24 are for use in enabling OBC 12 to be used interchangeably with a multi-phase mains supply and a single-phase mains supply. Input relay 24a is between the inputs of rails 22a and 22b. Input relay 24b is between the inputs of rails 22a and 22c. Each input relay 24a and 24b is switchable between opened and closed states. Controller 20 is operable to control the switching of input relays 24.

An opened input relay disconnects the two rails that the input relay is between.

Input relays 24 are both shown in FIG. 2 in an opened state. Thus, the input of rail 22b is not connected to the input of rail 22a as input relay 24a between rails 22a and 22b is opened. Likewise, rail 22c is not connected to the input of rail 22a as input relay 24b between rails 22a and 22c is opened.

Mains supply 16 is a three-phase mains supply. In this case, input relays 24 are opened whereby all three rails 22 may individually directly connect with mains supply 16 via EVSE 18 as shown in FIG. 2. Particularly, each rail 22a, 22b, 22c directly connects, via respective nodes L_{1′}, L_{2′}, L_{3′} of OBC 12, with a corresponding line L₁, L₂, L₃ of mains supply 16 and, via a neutral node N′ of the OBC, with a neutral line N of the mains supply.

As described, OBC 12 is not directly connected to the electrical grid but is connected to the electrical grid by means of EVSE 18 which acts as an additional element to ensure a safe and controlled connection of the OBC to the electrical grid. When both EVSE 18 and OBC 12 are ready for the charging operation, the EVSE closes its contactors and the OBC receives the AC electrical power from the AC grid.

Strictly as an example, each rail 22a, 22b, and 22c can provide a peak 3.6 kW of electrical power for charging traction battery 14. As such, in this example, OBC 12 can provide a peak 10.8 kW (3*3.6 kW=10.8 kW) of electrical power for charging traction battery 14. As such, in this example, OBC 12 is a “11 kW” OBC.

The “peak” electrical power provided by each rail 22 is the maximum electrical power that the rail can provide when activated (i.e., maximum operating power). Conversely, each rail 22 has a minimum electrical power that the rail has to provide for that rail to be activated (i.e., minimum operating power). For instance, strictly as an example, the minimum operating power is 500 W. As such, in this example, rail 22a has to provide at least 500 W of electrical power when activated; and rail 22a can provide up to 3.6 kW of electrical power when activated. Likewise, rail 22b and rail 22c each has to provide at least 500 W of electrical power when activated and rail 22b and rail 22c each can provide up to 3.6 kW of electrical power.

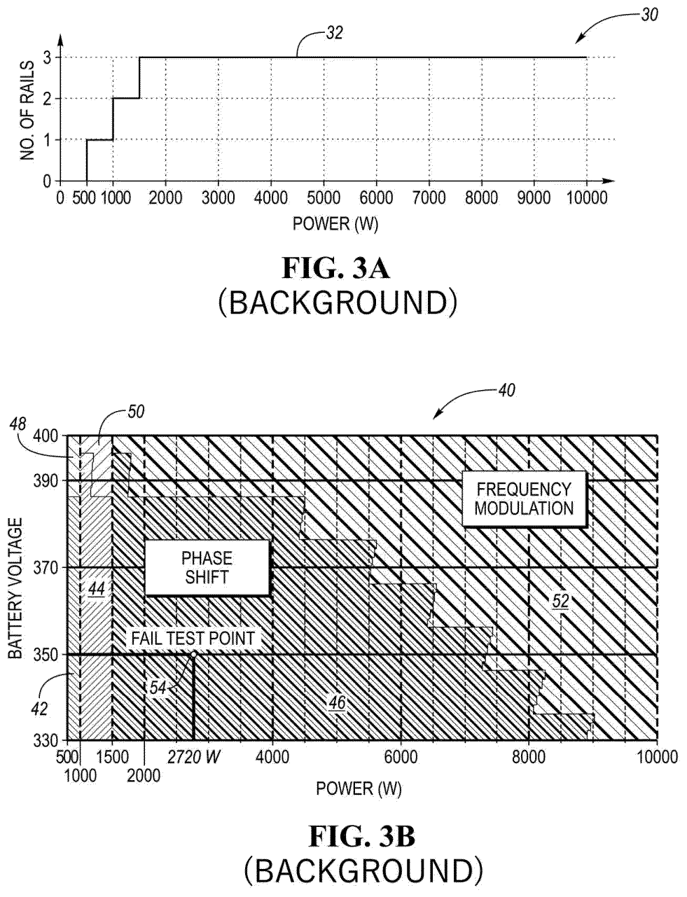

Referring now to FIG. 3A, with continual reference to FIG. 2, a graph 30 is shown. Graph 30 includes a plot 32 of a number of rails 22 of OBC 12 that are activated as a function of electrical power provided by the OBC according to an ordinary rail activation strategy.

The ordinary rail activation strategy is characterized in that rails 22 are sequentially activated as the electrical power to be provided by OBC 12 increases in multiples of the minimum operating power per rail.

For instance, with the minimum operating power being 500 W per rail, controller 20 activates a first rail (one rail activated) and then activates a second rail (two rails activated) and then activates a third rail (three rails activated) as the electrical power to be provided by OBC 12 increases from 500 W (i.e., one times the minimum operating power) to 1000 W (i.e., two times the minimum operating power) to 1500 W (i.e., three times the minimum operating power). Accordingly, as indicated by plot 32 in graph 30, one rail 22 is activated for OBC 12 to provide 500 to 1000 W of electrical power, two rails 22 are activated for OBC 12 to provide 1000 to 1500 W of electrical power, and three rails 22 are activated for OBC 12 to provide 1500 W or more (up to 10.8 kW in this example) electrical power.

An operating characteristic of OBC 12 is that when multiple rails are activated, the multiple rails split equally the total provided electrical power. As such, for instance, when rails 22a and 22b are activated to provide a total electrical power of 1200 W, rail 22a provides 600 W of electrical power and rail 22b equally provides 600 W of electrical power (i.e., 600 W+600 W=1200 W). Likewise, for instance, when rails 22a, 22b, and 22c are activated to provide a total operating power of 6000 W, each rail 22a, 22b, and 22c equally provides 2000 W of electrical power (i.e., 2000 W+2000 W+2000 W=6000 W).

Further, a single rail 22 only operates up when there is enough power required to activate the next rail. This maximizes the scenarios when the three rails are activated, and the ageing is shared between them. Rails 22 only work “alone” at minimum to medium power ranges (low stress, low ageing). With this strategy, with a basic interchange of which is the first, second and third rails activated (sequenced rotation one, two, three or random selection), the ageing of the three rail circuits is equalized.

Referring now to FIG. 3B, with continual reference to FIG. 3A, a graph 40 (“ordinary rail activation strategy graph”) depicting different regions of operation of OBC 12 when the OBC is operated according to the ordinary rail activation strategy is shown. The different regions of operation of OBC 12 depicted in ordinary rail activation strategy graph 40 pertain to the OBC being controlled by controller 20 with either a phase-shift mode (PSM) control or a frequency modulation mode (FMM) control.

The regions of operation of OBC 12 comprise operating points of the OBC. Each operating point of OBC 12 is associated with (i) the electrical power provided by the OBC, (ii) the electrical voltage and the electrical current of the electrical power provided by the OBC, and (iii) the number of rails 22 that are activated for the OBC to provide the electrical power. For instance, when OBC 12 is operating at operating point 54 (shown in graph 40 and referenced as fail test point as discussed below), (i) the OBC provides 2720 W of electrical power, (ii) the OBC provides the 2720 W of electrical power with 350 V of voltage and 7.77 A of current (2720 W/350 V=7.77 A), and (iii) all three rails of the OBC are activated.

Another operating characteristic of OBC 12 is that the areas of the PSM control regions of operation and the areas of the FMM control regions of operation are defined by the hardware configuration of the OBC. As set by the hardware configuration of OBC 12, the OBC is controlled with either PSM control or FMM control depending on the operating points of the OBC. More particularly, as set by the hardware configuration of OBC 12, the OBC is controlled with either PSM control or FMM control depending on (i) the electrical power provided by the OBC, (ii) the electrical voltage and the electrical current of the electrical power provided by the OBC, and (iii) the number of rails of the OBC that are activated for the OBC to provide the electrical power.

For example, regarding the hardware configuration of OBC 12 defining the PSM control regions and the FMM control regions, a standard approach in using resonant converters (e.g., LLC, LCL, LCC, CCL, etc., resonant converters) for rails 22 is to try to make the converters operate at their most efficient and less noisy operating points which are close to the resonant frequency. In these operating points the typical control approach is to modulate only the switching frequency to regulate the desired magnitude (output current or output voltage mainly). To operate a converter at lower output voltages and mid/low power it is needed to increase the switching frequency which is limited by the hardware circuitry that is responsible for driving the power semiconductors of the converter. To cope with this limitation, a maximum switching frequency is set at which the phase-shift technique (i.e., PSM control) between branches of a MOSFET full bridge of the converter is employed. This reduces the mean voltage applied to the resonant tank and allows to meet lower required input/output gains.

In ordinary rail activation strategy graph 40, the “x”-axis is the electrical power (labeled “Power”) provided by OBC 12 and the “y”-axis is the voltage of the electrical power provided by the OBC. The voltage is labeled “Battery Voltage” as traction battery 14 is to be charged to this voltage. The current of the electrical power provided by the OBC is the electrical power divided by the voltage.

In ordinary rail activation strategy graph 40, operation regions 42, 44, and 46 (relatively shaded darker regions in 40) pertain to when PSM control is implemented and operation ranges 48, 50, and 52 (relatively unshaded lighter regions in graph 40) pertain to when FMM control is implemented. Particularly, PSM operation region 42 and FMM operation region 48 correspond to when one rail 22 is activated; PSM operation region 44 and FMM operation region 50 correspond to when two rails 22 are activated; and PSM operation region 46 and FMM operation region 52 correspond to when three rails 22 are activated.

As shown in graph 40, according to the ordinary rail activation strategy in which rails 22 are sequentially activated as the electrical power to be provided by OBC 12 increases in multiples of the minimum operating power per rail (graph 40 being based on the minimum operating power being 500 W), OBC 12 is almost exclusively controlled with the PSM control when either one rail is activated or when two rails are activated. This is evident as the area of PSM operation region 42 is greatly larger than the area of FMM operation region 48 when one rail is activated and as the area of PSM operation region 44 is greatly larger than the area of FMM operation range 50 when two rails are activated.

However, as further shown in graph 40, when three rails are activated, OBC 12 is controlled with the PSM control for a relatively large amount of the operating points and is controlled with the FMM control for the remaining relatively large amount of the operating points. This is evident as the area of PSM operation region 46 and the area of FMM operation region 52 are roughly equal (i.e., 50% PSM and 50% FMM on the battery voltage vs power operating conditions). (The areas of PSM operation region 46 and FMM operation region 52 being roughly equal is just an example. Nonetheless, when three rails are activated, the OBC is controlled for a relatively large amount of the operating points with PSM control and for a relatively large amount of the operating points with FMM control.)

An issue is that when operated with PSM control at certain (relatively few) of the operating points, OBC 12 may be at risk of generating electromagnetic interference surpassing regulation thresholds. For instance, at failure test operating point 54 in which OBC 12 is being operated in PSM control with the electrical power provided by the OBC being 2720 W at a voltage of 350 V with three rails being activated, the OBC may be at risk of generating electromagnetic interference that surpasses regulation thresholds.

On the other hand, when operated with FMM control at any of the operating points, OBC 12 is not at risk of generating electromagnetic interference surpassing regulation thresholds. For instance, if OBC 12 was operated with FMM control at failure test operating point 54, then the OBC would not be at risk of generating electromagnetic interference that surpasses regulation thresholds.

In accordance with embodiments of the present disclosure, controller 20 controls OBC 12 to maximize the use of FMM control in the usage of rails 22 of the OBC in order to improve the behavior with respect to interferences emission for a wider operating range as well as to improve efficiency. In this regard, controller 20 implements a novel rail activation strategy to decide when each rail 22 is activated in order to use the rails at higher electrical powers for a wider operating range so that the FMM control range is increased against the PSM control range.

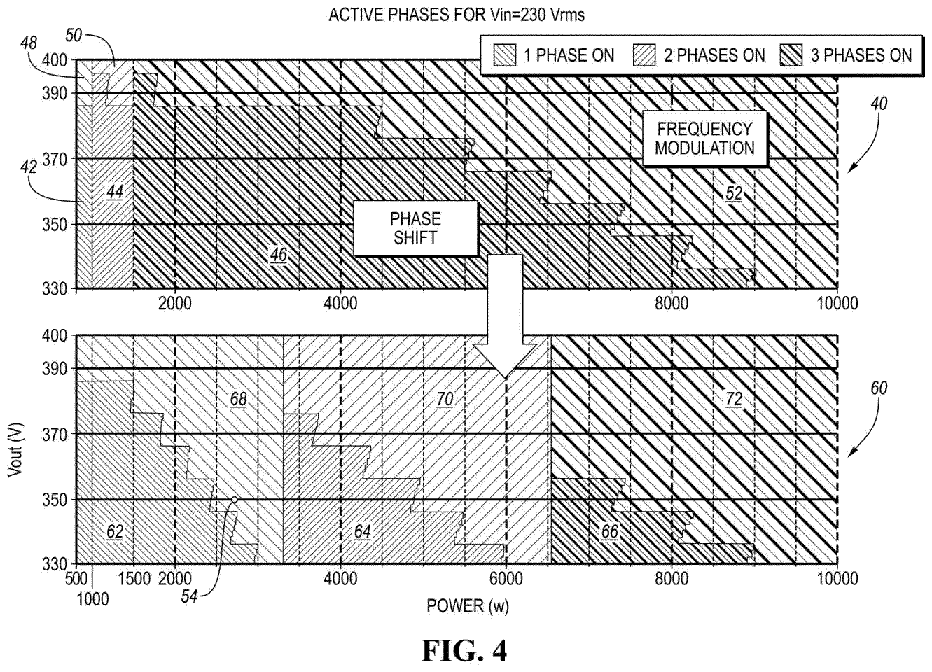

Referring now to FIG. 4, a side-by-side view of ordinary rail activation strategy graph 40 of FIG. 3B and a novel rail activation strategy graph) 60 is shown. Novel rail activation strategy graph 60 depicts different regions of operation of OBC 12 when the OBC is operated according to the novel rail activation strategy. The different regions of operation of OBC 12 depicted in novel rail activation strategy graph 60 pertain to the OBC being controlled by controller 20 with either the PSM control or the FMM control.

As indicated, the areas of the PSM control regions of operation and the areas of the FMM control regions of operation are defined by the hardware configuration of the OBC. More particularly, the hardware of the OBC is the hardware forming the rail circuits (e.g., power plant, MOSFETs, resonant capacitor, resonant inductor, transformer leakage, turn ratio, output rectification, etc.). Controller 20 is what makes the hardware to operate in PSM or FMM. When a rail circuit is requested to work at higher power conditions, then the rail circuit will move from PSM to FMM. So, with the novel rail activation strategy, the idea is always to operate the OBC with the minimum possible number of active rail circuits, so that the active rail circuits are more likely to be operated in FMM. Hence, understanding the hardware as the electronic components, the hardware configuration of the OBC is not changed. The way controller 20 drives or operates the hardware is what is changed to make the hardware work in PSM or FMM. Controller 20 applies PSM or FMM depending on the input/output voltage gain, load, and maximum allowed switching frequency.

The novel rail activation strategy is characterized in that rails 22 are sequentially activated as the electrical power to be provided by OBC 12 increases in multiples of a selected operating power per rail greater than the minimum operating power per rail. As an example, the greater selected operating power is 3.33 kW, which is appropriate as each rail 22 can provide a maximum operating power of 3.6 kW. In this case, according to the novel rail activation strategy, controller 20 activates a first rail (one rail activated) and then activates a second rail (two rails activated) and then activates a third rail (three rails activated) as the electrical power to be provided by OBC 12 increases from 3.33 kW (i.e., one times the greater selected operating power) to 6.67 kW (i.e., two times the greater selected operating power) to 10 kW (i.e., three times the greater selected operating power). Accordingly, one rail 22 is activated for OBC 12 to deliver 500 W to 3.33 kW of electrical power, two rails 22 are activated for OBC 12 to deliver 3.33 kW to 6.67 kW of electrical power, and three rails 22 are activated for OBC 12 to deliver 6.66 kW to 10 kW of electrical power.

In the above example, the “power range” when one rail 22 is activated is 3.33 kW (3.33 kW=3.33 kW−0 W) and when two rails 22 are activated is 3.34 kW (3.34 kW=6.67 kW−3.33 kW), and 3.33 kW (3.33 kW=10 kW−6.67 kW).

In above example where the selected operating power is 3.3 kW, the selected operating power is obtained by dividing the range of electrical power to be provided by OBC 12 by the number of rails of the OBC. As such, with the range of electrical power to be provided by OBC 12 being 10 kW, as indicated in graphs 40 and 60, and with the number of rails of the OBC being three, the selected operating power range is 3.33 kW (i.e., 3.33 kW=10 kW/3).

In novel rail activation strategy graph 60, operation regions 62, 64, and 66 (relatively shaded darker regions in graph 60) pertain to when PSM control is implemented and operation ranges 68, 70, and 72 (relatively unshaded lighter regions in graph 60) pertain to when FMM control is implemented. Particularly, PSM operation region 62 and FMM operation region 68 correspond to when one rail 22 is activated; PSM operation region 64 and FMM operation region 70 correspond to when two rails 22 are activated; and PSM operation region 66 and FMM operation region 72 correspond to when three rails 22 are activated.

As shown in graph 60, according to the novel rail activation strategy in which rails 22 are sequentially activated as the electrical power to be provided by OBC 12 increases in multiples of a selected operating power per rail greater than the minimum operating power per rail (graph 60 being based on the greater selected operating power being 3.33 kW), OBC 12 is controlled with the FMM control for a relatively large amount of the operating points when one rail, two rails, or three rails are activated. This is evident as the area of FMM operation region 68 is roughly equal to the area of PSM operation region 62 when one rail is activated; the area of FMM operation region 70 is greater than the area of PSM operation region 64 when two rails are activated; and the area of FMM operation region 72 is even greater than the area of PSM operation region 66 when three rails are activated.

Accordingly, compared to the ordinary rail activation strategy, the FMM control of OBC 12 is more widely used when the novel rail activation strategy is employed. For instance, pursuant to the novel rail activation strategy, the FMM control would be used at failure test operating point 54 (as opposed to the PSM control being used at failure test operating point 54 pursuant to the ordinary rail activation strategy). Consequently, with the use of the novel rail activation strategy, OBC 12 is not at risk of generating electromagnetic interference that surpasses regulation at failure test operating point.

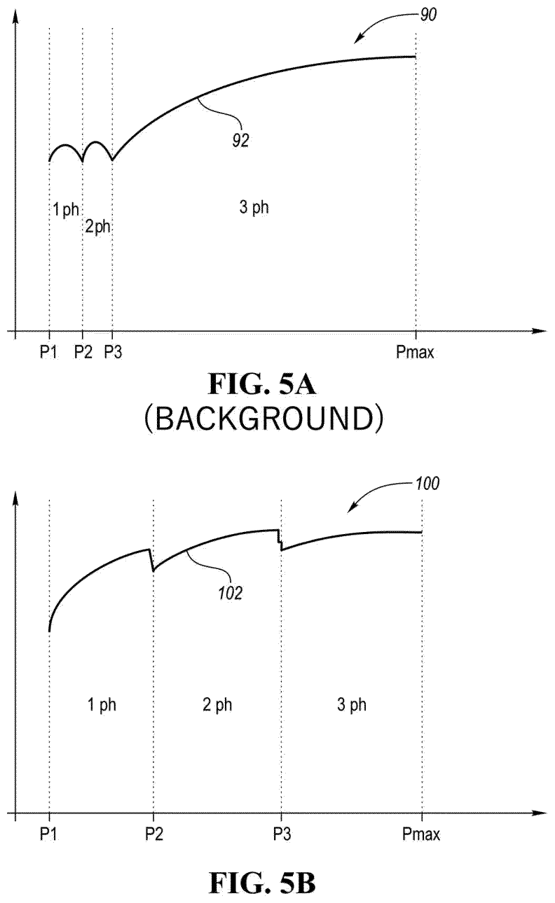

Referring now to FIGS. 5A and 5B, with continual reference to FIG. 4, a qualitative efficiency graph 90 (shown in FIG. 5A) in which it can be observed how efficiency would look like with the ordinary rail activation strategy and a qualitative efficiency graph 100 (shown in FIG. 5B) in which it can be observed how efficiency would look like with the novel rail activation strategy are shown. Ordinary rail activation strategy qualitative efficiency graph 90 includes a plot 92 of the regions of operation of OBC 12 in which one rail, two rails, and three rails of the OBC are activated as a function of electrical power provided by the OBC when the OBC is operated according to the ordinary rail activation strategy. Novel rail activation strategy qualitative efficiency graph 100 includes a plot 102 of the regions of operation of OBC 12 in which one rail, two rails, and three rails of the OBC are activated as a function of electrical power provided by the OBC when the OBC is operated according to the novel rail activation strategy are respectively shown.

Plot 92 of qualitative efficiency graph 90 has a form corresponding to ordinary rail activation strategy graph 40. Particularly, as shown in both graphs 40 and 90, one rail is activated for a relatively small electrical power range “P1”-“P2” (e.g., 500 W to 1000 W), two rails are activated for a relatively small electrical power range “P2”-“P3” (e.g., 1000 W to 1500 W), and three rails are activated for a relatively much larger electrical power range “P3”-“Pmax” (e.g., 1500 W to 10 kW).

Plot 102 of qualitative efficiency graph 100 has a form corresponding to novel rail activation strategy graph 60. Particularly, as shown in both graphs 60 and 100, one rail is activated for a relatively large electrical power range “P1”-“P2” (e.g., 500 W to 3.33 kW), two rails are activated for a roughly equally relatively large electrical power range “P2”-“P3” (e.g., 3.33 kW to 6.67 kW), and three rails are activated for a roughly equally relatively large electrical power range “P3”-“Pmax” (e.g., 6.67 kW to 10 kW).

As such, as seen from a comparison of novel rail activation strategy graph 100 with ordinary rail activation strategy graph 90, the electrical power operating ranges in which just one rail is activated or just two rails are activated are much larger for the novel rail activation strategy than for the ordinary rail activation strategy and, as a result, the electrical power operating range in which all three rails are activated is much smaller for the novel rail activation strategy than for the ordinary rail activation strategy.

Furthermore, novel rail activation strategy qualitative efficiency graph 100 is indicative of the efficiency curve vs. the power transferred. This also shows that at low and mid powers, the novel rail activation strategy is providing better efficiency, thus increasing the efficiency of the total battery charging process. Consequently, a shorter charging cycle can be achieved.

As set forth, the novel rail activation strategy changes the ordinary rail activation strategy to decide when each rail 22 is activated in order to use the rails at higher electrical powers for a wider operating range so that the FMM control range is increased against the PSM control range. With the FMM control, the interference band is wider and so the interference peaks are smaller, enabling EMI (electromagnetic interference) international standards compliance. This also improves the range working with improved efficiency.

Further, according to embodiments of the present disclosure, rail activation selection is done with rail ageing control. For instance, activation time of the rails are monitored and the first rail to be activated during a given power charging operation of OBC 12 is the rail that has the least activation time with any second rail to be activated during the given power charging operation being the next rail having the least activation time. Alternatively, the first rail to be activated is randomly selected with any second rail to be activated also being randomly selected. Further, the monitoring of each rail may include recording its operation time and the power provided by rail during the operation time. In this regard, as ageing is to be equalized, the power at which a rail is operated is also relevant.

As described, the novel rail activation strategy provides a software-only solution to address a complex topic of EMC compliance by adjusting dynamically hardware usage in an optimal operating point. The novel rail activation strategy minimizes phase shift mode (PSM) control by decreasing the operation use with all three rails working in parallel. The frequency modulation mode (FMM) control is thereby effectively increased. The intention to increase use of the FMM control and decrease use of the PSM control is purposeful as it is realized that OBC 12 with FMM control provides a better behavior regarding the generation of electromagnetic interferences. By using one rail and two rail modes to higher powers, the total range of PSM control usage is minimized. Also, efficiency is improved. Particularly, the efficiency is improved at mid and low power working ranges, as the rails are typically designed to be more efficient at high working power.

As described, controller 20 cannot choose between the PSM control and the FMM control for a particular operating point of OBC 12 because of how the hardware configuration of the OBC is to be used. The novel rail activation strategy solves this by forcing adjustment of the power ranges so that relatively much more operating points function with the FMM control.

Further, controller 20 may associate hysteresis with the selected operating power to prevent continuous switching on/off of phases while the requested power meets exactly the value of the selected operating power.

Benefits of the novel rail activation strategy may include EMC performance optimization when operating at low or mid power conditions; a software-only solution, avoiding the need of more expensive components in a size-tight scenario; and efficiency improvement of the total charging process, as the rails operate in the more efficient conditions (high power transfer).

Item 1: In an embodiment, the present disclosure provides a charger comprising first and second rail circuits, each of the first and second rail circuits providing power when activated, the charger further comprising a controller configured to activate the first rail circuit without activating the second rail circuit in accordance with a determination that a power greater than a first power and less than a second power is to be provided and activate the first and second rail circuits in accordance with a determination that a power greater than the second power is to be provided, wherein a power difference between the second power and the first power is greater than the first power.

Item 2: In another embodiment, the present disclosure provides the charger according to Item 1 further comprising a third rail circuit, the third rail circuit providing power when activated, and the controller is configured to activate the first, second, and third rail circuits in accordance with a determination that a power greater than a sum of the second power and the power difference is to be provided.

Item 3: In another embodiment, the present disclosure provides the charger according to Item 2, wherein the controller is configured to activate the first and second rail circuits without activating the third rail circuit in accordance with a determination that a power greater than the second power and less than a third power is to be provided, wherein the third power is a sum of the second power and the power difference.

Item 4: In another embodiment, the present disclosure provides the charger according to any of Items 2 and 3, wherein the second power is equal to a maximum power of the first, second, and third rail circuits divided by three.

Item 5: In another embodiment, the present disclosure provides the charger according to any preceding Item, wherein each activated rail circuit is controlled by one of a phase-shift mode (PSM) control or a frequency modulation mode (FMM) control depending on an operating point corresponding to the power provided, a first power range of the power difference between the first power and the second power at least partially defines a first operation region comprising first operating points, and the controller is configured to select a value of the first power range to thereby set a corresponding number of the first operating points associated to the FMM control.

Item 6: In another embodiment, the present disclosure provides the charger according to Item 5, wherein the controller is configured to select a larger value of the first power range to thereby set an increased corresponding number of the first operating points associated to the FMM control.

Item 7: In another embodiment, the present disclosure provides the charger according to any of Items 5 and 6, wherein the controller is configured to select a value for the second power in order to select the value for the first power range.

Item 8: In another embodiment, the present disclosure provides the charger according to any of Items 5, 6, and 7 further comprising a third rail circuit, the third rail circuit providing power when activated, wherein the controller is configured to activate the first, second, and third rail circuits in accordance with a determination that a power greater than a third power greater than the second power is to be provided.

Item 9: In another embodiment, the present disclosure provides the charger according to Item 8 wherein a second power range of a power difference between the second power and the third power at least partially defines a second operation region comprising second operating points, and the controller is configured to select a value of the second power range to thereby set a number of the second operating points associated to the FMM control.

Item 10: In another embodiment, the present disclosure provides the charger according to Item 9, wherein the controller is configured to select a larger value of the second power range to thereby set an increased corresponding number of the second operating points to the FMM control.

Item 11: In another embodiment, the present disclosure provides the charger according to any of the preceding Items, wherein the first power is a minimum power that each of the first and second rail circuits at least provide when activated.

Item 12: In another embodiment, the present disclosure provides the charger according to Item 11, wherein the minimum power is at least 500 Watts.

Item 13: In another embodiment, the present disclosure provides the charger according to any of the preceding Items, wherein the first and second rail circuits provide the same powers when activated.

Item 14: In another embodiment, the present disclosure provides the charger according to any of the preceding Items, wherein the second power is equal to a maximum power of the first and second rail circuits divided by two.

Item 15: In another embodiment, the present disclosure provides the charger according to any of the preceding Items, wherein the controller is configured to activate the second rail circuit instead of the first rail circuit in accordance with the determination that the power greater than the first power and less than the second power is to be provided.

Item 16: In an embodiment, the present disclosure provides an on-board battery charger (OBC) comprising first, second, and third rail circuits, each of the first, second, and third rail circuits providing at least a minimum power when activated, and the OBC further comprising a controller configured to sequentially activate the rail circuits in accordance with a determination that a power is to be provided as the power to be provided is increased in multiples of a power per rail circuit greater than the minimum power.

Item 17: In another embodiment, the present disclosure provides the OBC according to Item 16, wherein each activated rail circuit is controlled by one of a phase-shift mode (PSM) control or a frequency modulation mode (FMM) control depending on an operating point corresponding to the power provided, a first power range between the minimum power and the power per rail circuit at least partially defines a first operation region comprising first operating points, a second power range between the power per rail circuit and twice the power per rail circuit at least partially defines a second operation region comprising second operating points, and a third power range between twice the power per rail circuit and thrice the power per rail circuit at least partially defines a third operation region comprising third operating points, and the controller is configured to select the first, second, and third power ranges to thereby set a corresponding number of the first, second, and third operating points associated to the FMM control.

Item 18: In another embodiment, the present disclosure provides the OBC according to any of Items 16 and 17, wherein the first, second, and third rail circuits provide the same powers when activated.

Item 19: In another embodiment, the present disclosure provides a non-transitory computer readable storage medium comprising stored computer executable instructions to cause a controller to activate a first rail circuit of a charger, without activating any other rail circuit of the charger, in accordance with a determination that a power greater than a first power and less than a second power is to be provided, wherein a power difference between the second power and the first power is greater than the first power, and the non-transitory computer readable storage medium further comprising stored computer executable instructions to cause the controller to activate the first rail circuit and a second rail circuit of the charger in accordance with a determination that a power greater than the second power is to be provided.

Item 20: In another embodiment, the present disclosure provides the non-transitory computer readable storage medium according to Item 19, wherein the non-transitory computer readable storage medium further comprising stored computer executable instructions to cause the controller to activate the first rail circuit, the second rail circuit, and a third rail circuit of the charger in accordance with a determination that a power greater than a sum of the second power and the power difference is to be provided.

While exemplary embodiments are described above, it is not intended that these embodiments describe all possible forms of the present disclosure. Rather, the words used in the specification are words of description rather than limitation, and it is understood that various changes may be made without departing from the spirit and scope of the disclosure. Additionally, the features of various implementing embodiments may be combined to form further embodiments of the present disclosure.

What is claimed is:

1. A charger comprising:
first and second rail circuits, each of the first and second rail circuits providing power when activated; and
a controller configured to activate the first rail circuit without activating the second rail circuit in accordance with a determination that a power greater than a first power and less than a second power is to be provided and the controller is configured to activate the first and second rail circuits in accordance with a determination that a power greater than the second power is to be provided, wherein a power difference between the second power and the first power is greater than the first power.

2. The charger of claim 1 further comprising:
a third rail circuit, the third rail circuit providing power when activated; and
wherein the controller is configured to activate the first, second, and third rail circuits in accordance with a determination that a power greater than a sum of the second power and the power difference is to be provided.

3. The charger of claim 2 wherein:
the controller is configured to activate the first and second rail circuits without activating the third rail circuit in accordance with a determination that a power greater than the second power and less than a third power is to be provided, wherein the third power is a sum of the second power and the power difference.

4. The charger of claim 2 wherein:
the second power is equal to a maximum power of the first, second, and third rail circuits divided by three.

5. The charger of claim 1 wherein:
each activated rail circuit is controlled by one of a phase-shift mode (PSM) control or a frequency modulation mode (FMM) control depending on an operating point corresponding to the power provided;
a first power range of the power difference between the first power and the second power at least partially defines a first operation region comprising first operating points; and
the controller is configured to select a value of the first power range to thereby set a corresponding number of the first operating points associated to the FMM control.

6. The charger of claim 5 wherein:
the controller is configured to select a larger value of the first power range to thereby set an increased corresponding number of the first operating points associated to the FMM control.

7. The charger of claim 5 wherein:
the controller is configured to select a value for the second power in order to select the value for the first power range.

8. The charger of claim 5 further comprising:
a third rail circuit, the third rail circuit providing power when activated; and
wherein the controller is configured to activate the first, second, and third rail circuits in accordance with a determination that a power greater than a third power greater than the second power is to be provided.

9. The charger of claim 8 wherein:
a second power range of a power difference between the second power and the third power at least partially defines a second operation region comprising second operating points; and
the controller is configured to select a value of the second power range to thereby set a number of the second operating points associated to the FMM control.

10. The charger of claim 9 wherein:
the controller is configured to select a larger value of the second power range to thereby set an increased corresponding number of the second operating points to the FMM control.

11. The charger of claim 1 wherein:
the first power is a minimum power that each of the first and second rail circuits at least provide when activated.

12. The charger of claim 11 wherein:
the minimum power is at least 500 Watts.

13. The charger of claim 1 wherein:
the first and second rail circuits provide the same powers when activated.

14. The charger of claim 1 wherein:
the second power is equal to a maximum power of the first and second rail circuits divided by two.

15. The charger of claim 1 wherein:
the controller is configured to activate the second rail circuit instead of the first rail circuit in accordance with the determination that the power greater than the first power and less than the second power is to be provided.

16. An on-board battery charger (OBC) comprising:
first, second, and third rail circuits, each of the first, second, and third rail circuits providing at least a minimum power when activated; and
a controller configured to sequentially activate the rail circuits in accordance with a determination that a power is to be provided as the power to be provided is increased in multiples of a power per rail circuit greater than the minimum power.

17. The OBC of claim 16 wherein:
each activated rail circuit is controlled by one of a phase-shift mode (PSM) control or a frequency modulation mode (FMM) control depending on an operating point corresponding to the power provided;
a first power range between the minimum power and the power per rail circuit at least partially defines a first operation region comprising first operating points;
a second power range between the power per rail circuit and twice the power per rail circuit at least partially defines a second operation region comprising second operating points;
a third power range between twice the power per rail circuit and thrice the power per rail circuit at least partially defines a third operation region comprising third operating points;
and the controller is configured to select the first, second, and third power ranges to thereby set a corresponding number of the first, second, and third operating points associated to the FMM control.

18. The OBC of claim 16 wherein:
the first, second, and third rail circuits provide the same powers when activated.

19. A non-transitory computer readable storage medium comprising stored computer executable instructions to cause a controller to:
activate a first rail circuit of a charger, without activating any other rail circuit of the charger, in accordance with a determination that a power greater than a first power and less than a second power is to be provided, wherein a power difference between the second power and the first power is greater than the first power; and
activate the first rail circuit and a second rail circuit of the charger in accordance with a determination that a power greater than the second power is to be provided.

20. The non-transitory computer readable storage medium of claim 19 further comprising stored computer executable instructions to cause the controller to:
activate the first rail circuit, the second rail circuit, and a third rail circuit of the charger in accordance with a determination that a power greater than a sum of the second power and the power difference is to be provided.
